(19) United States
(12) Patent Application Publication
(10) Pub. No.: US 2005/0057915 A1
(43) Pub. Date: Mar. 17, 2005

(54) Patterned light guide plate and display device having same

(75) Inventor: Kun-Jung Tsai, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/973,055

(22) Filed: Oct. 25, 2004

(30) Foreign Application Priority Data
Feb. 12, 2003 (TW) 92133855

(51) Int. Cl. F21V 7/04

(52) U.S. Cl. 362/31

(57) ABSTRACT

A display device (20) includes a light guide plate (200) and a row of light sources (211). The light guide plate includes an emitting surface (220), a bottom surface (230) opposite to the emitting surface, and an incident surface (210) adjoining the emitting surface and the bottom surface. A number of wedgy recesses (234) are defined in the light guide plate at the bottom surface. The light sources are disposed adjacent the incident surface of the light guide plate. Inclined planes bounding the recesses obliquely face both the incident surface and the emitting surface. The inclined planes reflect light and form bright spots on the emitting surface. The bright spots cooperatively form a desired pattern similar to a pattern of the recesses themselves. There is no need to form patterns on a separate shell. The relatively fewer components required reduces costs.

### BACKGROUND OF THE INVENTION

1. Field of the Invention

The present invention relates to light guide plates used to display particular predetermined images, and to display devices using such light guide plates.

2. Description of the Prior Art

A display device for displaying a desired pattern generally includes a light source, a light guide plate, and a shell. The light source emits light beams into the light guide plate. The light guide plate transforms the light beams into a plane light source. The shell is transparent, so that the plane light source is visible through the shell.

Referring to FIG. 5, a conventional light guide plate 100 generally comprises an emitting surface 110, a bottom surface 120 opposite to the emitting surface 110, an incident surface 130 adjoining the emitting surface 110 and the bottom surface 120, and a plurality of side surfaces 150. Light beams emitted from a light source enter the light guide plate 100 through the incident surface 130. A portion of these light beams is reflected at the bottom surface 120 one or more times, and the light beams emit from the emitting surface 110.

Commonly, predetermined patterns are formed on the transparent shell. The emitting surface 110 of the light guide plate 100 irradiates the patterns from underneath, thereby displaying the patterns. However, the use of the transparent shell necessarily adds to the cost of the display device.

### SUMMARY OF THE INVENTION

Accordingly, an objective of the present invention is to provide a light guide plate that can generate patterns inexpensively.

Another objective of the present invention is to provide a display device that can display patterns inexpensively.

In order to achieve the first above-mentioned objective, a light guide plate of a first embodiment of the present invention comprises an emitting surface, a bottom surface opposite to the emitting surface, an incident surface adjoining the emitting surface and the bottom surface, and a plurality of side surfaces. A plurality of wedgy recesses is defined in the light guide plate at the bottom surface. Inclined planes bounding the recesses obliquely face both the incident surface and the emitting surface. The inclined planes reflect light and form bright spots on the emitting surface. The bright spots cooperatively form a desired pattern similar to a pattern of the recesses themselves.

In order to achieve the second above-mentioned objective, a display device of the first embodiment of the present invention comprises a plurality of light sources, and the above-described light guide plate. The light sources are disposed adjacent the incident surface.

The present invention provides patterns by forming the recesses at the bottom surface of the light guide plate. Unlike in the prior art, there is no need to form patterns on a shell. The same display as that of a conventional display device is achieved, but with fewer components and reduced cost.

Other objects, advantages and novel features of the present invention will be apparent from the following detailed description of exemplary embodiments thereof with reference to the attached drawings, in which:

### BRIEF DESCRIPTION OF THE DRAWINGS

FIG. 1 is a schematic, isometric view of a display device according to a first embodiment of the present invention;

FIG. 2 is a bottom plan view of a light guide plate of the display device of FIG. 1, showing a distribution of recesses;

FIG. 3 is a cross-sectional view taken along line III-III of FIG. 1;

FIG. 4 is a schematic, isometric view of a display device according to a second embodiment of the present invention; and

FIG. 5 is an isometric view of a conventional light guide plate.

### DETAILED DESCRIPTION OF THE INVENTION

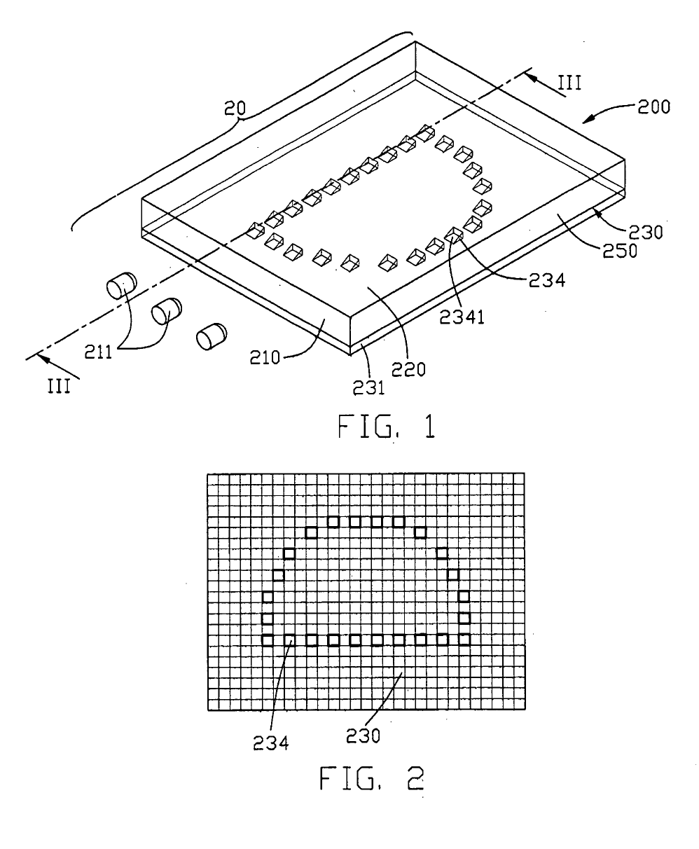

A display device 20 according to a first embodiment of the present invention is shown in FIG. 1. The display device 20 includes a light guide plate-like member 200, and a plurality of light sources 211. The light guide plate 200 is made of a transparent material such as acryl, glass, or polycarbonate. The light guide plate 200 includes an incident surface 210, an emitting surface 220 adjoining the incident surface 210, a bottom surface 230 adjoining the incident surface 210 and being opposite to the emitting surface 220, and three side surfaces 250. The light sources 211 are disposed adjacent the incident surface 210 and close to the bottom surface 230. In the illustrated embodiment, the light sources 211 are light emitting diodes.

A reflecting layer 231 is disposed on the bottom surface 230, in order to prevent light beams escaping from the bottom surface 230. The reflecting layer 231 reflects light beams back into the light guide plate 200, which increases a brightness of the display device 20. The reflecting layer 231 is formed by plating aluminum or silver on the bottom surface 230. Additional reflecting layers or sealing strips are used on the side surfaces 250, in order to prevent light beams escaping from the side surfaces 250.

Referring also to FIG. 2, the bottom surface 230 of the light guide plate 200 has an imaginary grid drawn thereon. A plurality of wedgy recesses 234 as working elements is defined in the light guide plate 200 at predetermined squares of the grid. A cross-section of each recess 234 defines a right-angled triangle. Inclined planes 2341 bounding the recesses 234 obliquely face both the incident surface 210 and the emitting surface 220. The recesses 234 cooperatively form a desired pattern. In the illustrated embodiment, the letter “D” is formed. If the squares are smaller and denser, a clearer pattern can be formed.

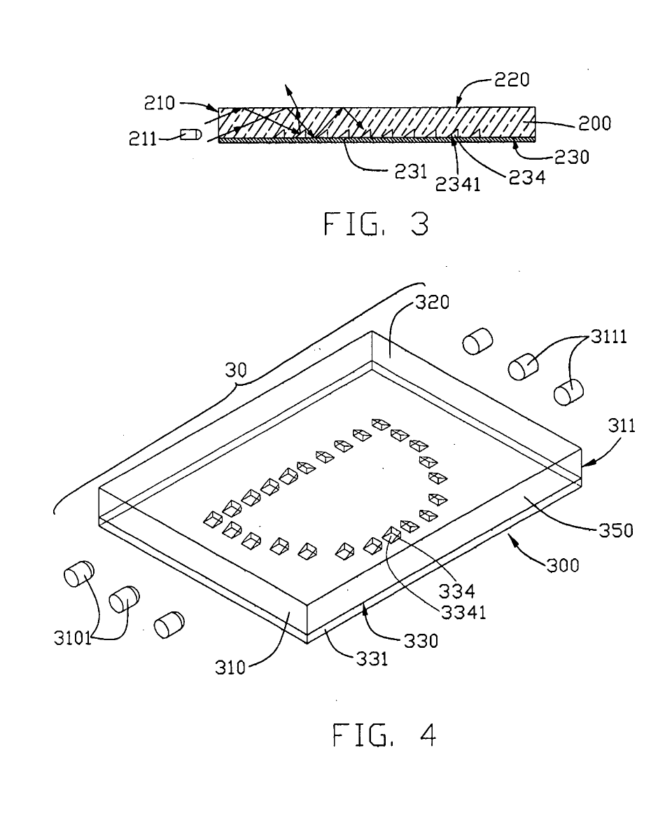

Referring to FIG. 3, the light sources 211 emit light beams into the light guide plate 200 through the incident surface 210. Light beams reaching the inclined planes 2341 of the recesses 234 are reflected toward the emitting surface 220. Light beams reaching the bottom surface 230 are reflected back into the light guide plate 200, whereupon they may undergo one or more further reflections. Thus, bright spots are formed on the emitting surface 220. The bright spots cooperatively form a pattern similar to the pattern formed by the recesses 234. That is, in the illustrated embodiment, the pattern formed is the letter “D.”

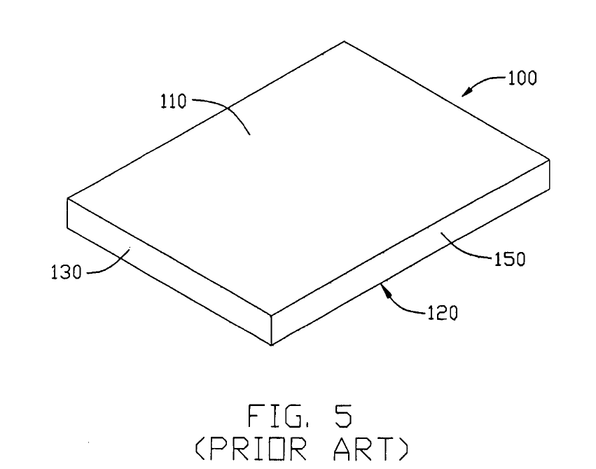

A display device 30 according a second embodiment of the present invention is shown in FIG. 4. The display device 30 includes a light guide plate 300, a plurality of light sources 3101, and a plurality of light sources 3111. The light guide plate 300 includes a light emitting surface 320, a bottom surface 330 opposite to the emitting surface 320, two opposite incident surfaces 310, 311 adjoining the emitting surface 320 and the bottom surface 330, and two opposite side surfaces 350. The light sources 3101, 3111 are respectively disposed adjacent the incident surfaces 310, 311. In the illustrated embodiment, the light sources 3101, 3111 are light emitting diodes.

A reflecting layer 331 is disposed on the bottom surface 330, in order to prevent light beams escaping from the bottom surface 330. The reflecting layer 331 reflects light beams back into the light guide plate 300, which increases a brightness of the display device 30. The reflecting layer 331 is formed by plating aluminum or silver on the bottom surface 330. Additional reflecting layers or sealing strips are disposed on the side surfaces 350, in order to prevent light beams escaping from the side surfaces 350.

The bottom surface 330 of the light guide plate 300 has an imaginary grid drawn thereon. A plurality of wedgy recesses 334 is defined in the light guide plate 300 at predetermined squares of the grid. A cross-section of each recess 334 defines a right-angled triangle. The recesses 334 cooperatively form a desired pattern. In the illustrated embodiment, the letter “D” is formed. If the squares are smaller and denser, a clearer pattern can be formed. An imaginary transverse midline divides the bottom surface 330 into two equally sized halves. The recesses 334 in one half are symmetric relative to the recesses 334 in the other half. In particular, inclined planes 3341 of half of the recesses 334 nearest to the incident surface 310 obliquely face both the incident surface 310 and the emitting surface 320. The inclined planes 3341 of the other half of the recesses 334 nearest to the incident surface 311 obliquely face both the incident surface 311 and the emitting surface 320.

The light sources 3101, 3111 emit light beams into the light guide plate 300 through the incident surfaces 310, 311. Light beams reaching the inclined planes 3341 of the recesses 334 are reflected toward the emitting surface 320. Light beams reaching the bottom surface 330 are reflected back into the light guide plate 300, whereupon they may undergo one or more further reflections. Thus, bright spots are formed on the emitting surface 320. The bright spots cooperatively form a pattern similar to the pattern formed by the recesses 334. That is, in the illustrated embodiment, the pattern formed is the letter “D.”

The present invention provides patterns by forming the recesses 234, 334 at the bottom surfaces 230, 330 of the light guide plates 200, 300 of the display devices 20, 30. Unlike in the prior art, there is no need to form patterns on a shell. The same display as that of a conventional display device is achieved, but with fewer components and reduced cost.

It is to be understood that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light guide plate, comprising:
an emitting surface;
a bottom surface opposite to the emitting surface, the bottom surface defining a plurality of wedgy recesses thereat; and
at least one incident surface adjoining the emitting surface and the bottom surface;
wherein inclined planes bounding the recesses obliquely face said incident surface and the emitting surface.

2. The light guide plate as recited in claim 1, wherein a cross-section of each recess defines a right-angled triangle.

3. The light guide plate as recited in claim 1, wherein a reflecting layer is formed on the bottom surface.

4. The light guide plate as recited in claim 1, further comprising at least two side surfaces having at least two reflecting layers respectively formed thereon.

5. The light guide plate as recited in claim 1, wherein the light guide plate is made of acryl, glass, or polycarbonate.

6. A display device, comprising at least one light source and a light guide plate, the light guide plate comprising:
an emitting surface;
a bottom surface opposite to the emitting surface, the bottom surface defining a plurality of wedgy recesses thereat; and
at least one incident surface adjoining the emitting surface and the bottom surface; wherein said light source is disposed adjacent said incident surface.

7. The display device as recited in claim 6, wherein a cross-section of each recess defines a right-angled triangle.

8. The display device as recited in claim 6, wherein a reflecting layer is formed on the bottom surface.

9. The display device as recited in claim 6, the light guide plate further comprises at least two side surfaces having at least two reflecting layers respectively formed thereon.

10. The display device as recited in claim 6, wherein the light guide plate is made of acryl, glass, or polycarbonate.

11. The display device as recited in claim 6, wherein said light source is at least one light emitting diode.

12. A display device comprising:
a light source; and
a light guide member having an incident surface facing said light source to receive light therefrom and an emitting surface to emit said light out of said light guide member, a plurality of working elements interferingly formed in a path of said light from said incident surface to said emitting surface in said light guide member and arranged in a predetermined pattern so as to reflect/diffuse said light and show said pattern.

13. The display device as recited in claim 12, wherein said working elements are formed along a surface parallel to said emitting surface.

14. The display device as recited in claim 12, wherein each of said working elements is formed as a wedge-shaped recess with a right-angled triangle cross-section.

15. The display device as recited in claim 14, wherein at least one inner inclined plane of each of said wedge-shaped-recess working elements faces said incident surface.

16. The display device as recited in claim 12, further comprising another light source located differently from said light source and said light guide member having another incident surface facing said another light source, and half of said working elements interferingly formed in a path of another light from said another light source to reflect/diffuse said another light.
